(19) United States
(12) Patent Application Publication
(10) Pub. No.: US 2010/0118231 A1
(43) Pub. Date: May 13, 2010

(54) LIQUID CRYSTAL DISPLAY DEVICE

(75) Inventors: Seung Gon Kang, Hwaseong-si (KR); Hyun Ha Hwang, Seoul (KR)

Correspondence Address: BIRCH STEWART KOLASCH & BIRCH, PO BOX 747, FALLS CHURCH, VA, 22040-0747, US

(73) Assignee: LG INNOTEK CO., LTD., Seoul (KR)

(21) Appl. No.: 12/530,515

(22) PCT Filed: Mar. 28, 2008
(86) PCT No.: PCT/KR2008/001767

§ 371 Date: Sep. 9, 2009

(30) Foreign Application Priority Data
Mar. 30, 2007 (KR) 10-2007-0031606

(51) Int. Cl. G02F 1/1335

(52) U.S. Cl. 349/65

(57) ABSTRACT

Disclosed is an LCD. The LCD includes a first substrate, a second substrate facing the first substrate, a liquid crystal layer interposed between the first substrate and the second substrate, and a light source disposed at a lateral side of the second substrate to emit light toward the second substrate. According to the LCD, light is incident into the second substrate through a lateral side of the second substrate and an image is displayed by the incident light. Since the LCD does not require an additional light guide plate, the LCD can have a slim structure as compared with an existing LCD.

### TECHNICAL FIELD

The embodiment relates to a liquid crystal display device.

### BACKGROUND ART

As information processing technology has been developed, flat display devices such as LCDs, PDPs or AMOLEDs have been extensively used. Since such flat display devices have been extensively used for portable devices, they must have a slim structure.

### DISCLOSURE OF INVENTION

### Technical Problem

The embodiment provides an LCD having a slim structure.

### Technical Solution

According to an embodiment, an LCD comprises: a first substrate; a second substrate facing the first substrate; a liquid crystal layer interposed between the first substrate and the second substrate; and a light source disposed at a lateral side of the second substrate to emit light toward the second substrate.

According to an embodiment, an LCD comprises: a liquid crystal panel including first and second substrates facing each other; a connection substrate connected with the second substrate; and a light source mounted on the connection substrate to emit light toward a lateral side of the second substrate.

According to an embodiment, an LCD comprises: a liquid crystal panel; a polarizing layer disposed inside the liquid crystal panel; a scattering member adhering to a bottom surface of the liquid crystal panel; and a light source disposed at a lateral side of the liquid crystal panel.

### Advantageous Effects

An LCD according to the embodiment displays an image by receiving light through a lateral side of a liquid crystal panel, i.e. a lateral side of a substrate included in the liquid crystal panel.

Accordingly, the LCD according to the embodiment does not require a member for guiding light, which is generated from a light source, in a horizontal direction. Thus, the LCD according to the embodiment has a slim structure.

### BRIEF DESCRIPTION OF THE DRAWINGS

FIG. 1 illustrates an exploded perspective view of an LCD according to a first embodiment;

FIG. 2 illustrates a sectional view of one section of an LCD according to a first embodiment;

FIG. 3 illustrates a sectional view of one section of a liquid crystal panel according to a second embodiment;

FIG. 4 illustrates a sectional view of one section of an LCD according to a third embodiment; and

FIG. 5 illustrates a sectional view of one section of an LCD according to a fourth embodiment.

### BEST MODE FOR CARRYING OUT THE INVENTION

In the description of an embodiment, it will be understood that, when a panel, a substrate, a layer (or film), a region, a pattern, a sheet, a member or a structure is referred to as being “on” or “under” another panel, another substrate, another layer (or film), another region, another pad, another member, another sheet or another structure, it can be “directly” or “indirectly” on the other panel, substrate, layer (or film), region, sheet, member or structure, or one or more intervening layers may also be present. Further, “on” or “under” of each layer is determined based on the drawing.

Further, the thickness or size of layers shown in the drawings can be simplified or exaggerated for the purpose of clear explanation. In addition, the size of each element may be reduced or magnified from the real size thereof.

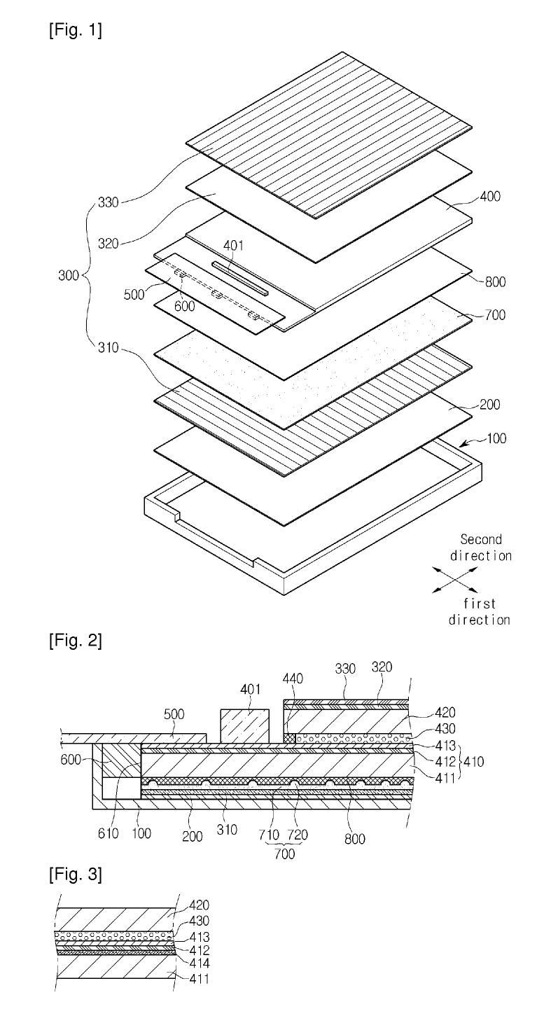

FIG. 1 illustrates an exploded perspective view of an LCD according to a first embodiment and FIG. 2 illustrates a sectional view of one section of an LCD according to a first embodiment.

Referring to FIG. 1 and FIG. 2, the LCD comprises a case 100, a reflective sheet 200, an optical sheet 300, a liquid crystal panel 400, a connection substrate 500, a light emitting diode 600 and a scattering member 700.

The case 100 receives the reflective sheet 200, the optical sheet 300, the liquid crystal panel 400, the connection substrate 500, the light emitting diode 600 and the scattering member 700.

The reflective sheet 200 is disposed inside the case 100 to reflect light, which is generated from the light emitting diode 600, in the upward direction.

The optical sheet 300 improves properties of transmitted light. The optical sheet 300 comprises a first prism sheet 310, a polarizing sheet 320 and a second prism sheet 330.

The first prism sheet 310 is disposed below the liquid crystal panel 400 and on the reflective sheet 200. In more detail, the first prism sheet 310 is interposed between the scattering member 700 and the reflective sheet 200. Further, the first prism sheet 310 makes contact with the scattering member 700 and the reflective sheet 200.

The first prism sheet 310 comprises a first prism pattern extending in the first direction. The first prism sheet 310 increases brightness of the LCD by refracting the transmitted light or guiding the transmitted light toward the liquid crystal panel 400.

The polarizing sheet 320 is disposed on the liquid crystal panel 400 to polarize the transmitted light in a predetermined direction. The polarizing sheet 320 can closely make contact with the liquid crystal panel 400.

The second prism sheet 330 is disposed on the polarizing sheet 320. The second prism sheet 330 comprises a second prism pattern extending in the second direction. Similarly to the first prism sheet 310, the second prism sheet 330 increases brightness of the LCD by refracting the transmitted light or guiding the transmitted light toward the liquid crystal panel 400.

The liquid crystal panel 400 is disposed inside the case 100 to adjust the intensity of the transmitted light in each pixel that is an image display unit. The liquid crystal panel 400 comprises a TFT substrate 410, a color filter substrate 420 and a liquid crystal layer 430.

The TFT substrate 410 forms the electric field in each pixel by receiving a signal through the connection substrate 500. The TFT substrate 410 comprises a base substrate 411, a polarizing layer 412 and a TFT layer 413.

The base substrate 411 is a glass substrate or a quartz substrate. The base substrate 411 is transparent or translucent.

The polarizing layer 412 is disposed on the base substrate 411. In more detail, the polarizing layer 412 is formed by coating the entire surface of the base substrate 411. The polarizing layer 412 polarizes the transmitted light in a predetermined direction.

For example, the polarizing layer 412 can be formed by coating a TCF (thin crystal film) on the base substrate 411.

In more detail, the polarizing layer 412 can be formed through the following process.

First, the base substrate 411 is cleaned. Next, the base substrate 411 is subject to plasma processing.

Then, the TCF is coated on the base substrate 411 through a FAS slot die coating method, a Mayer rod coating method and the like. At this time, a polarizing direction of the TCF is determined based on the coating direction.

The coated TCF is patterned by deionized water and the like.

Then, the TCF is stabilized by BaCl₂ and the like.

Last, the stabilized TCF is subject to heat treatment at the temperature of about 60° to 130°.

Further, the polarizing layer 412 comprises a reflective polarizing film such as a DBEF (dual brightness enhancement film). The reflective polarizing film polarizes a part of the transmitted light and reflect a remaining part of the transmitted light.

For example, the reflective polarizing film comprises several hundreds of compressed layers having refraction indices different from each other.

The TFT layer 413 is formed on the polarizing layer 412. The TFT layer 413 comprises a plurality of lines, a plurality of thin film transistors and pixel electrodes. The TFT layer 413 forms the electric field in each pixel by receiving an electrical signal through the connection substrate 500.

Further, the polarizing layer 412 may be disposed on the TFT layer 413.

The color filter substrate 420 is disposed above the TFT substrate 410 while facing the TFT substrate 410. The color filter substrate 420 comprises a plurality of color filters. The color filter substrate 420 is coupled with the TFT substrate 410 by a sealing member 440.

The liquid crystal layer 430 is interposed between the TFT substrate 410 and the color filter substrate 420. The liquid crystal layer 430 comprises liquid crystal.

Further, a driver IC 401 is mounted on the TFT layer 413.

The connection substrate 500 is electrically and physically connected with the TFT substrate 410. For example, the connection substrate 500 is electrically connected with lines formed on the TFT layer 413.

The connection substrate 500 is prepared in the form of a flexible circuit board. The connection substrate 500 is electrically connected with a main substrate for driving the LCD.

The light emitting diode 600 is directly mounted on the connection substrate 500. Further, the light emitting diode 600 is disposed at a lateral side of the liquid crystal panel 400. In more detail, the light emitting diode 600 is disposed at a lateral side of the TFT substrate 410, i.e. the base substrate 411.

The height of the light emitting diode 600 is substantially identical to or greater than the thickness of the TFT substrate 410.

The light emitting diode 600 generates light to emit the light toward the lateral side of the liquid crystal panel 400. In more detail, the light emitting diode 600 emits the light toward the lateral side of the base substrate 411. A light emitting surface 610, through which the light of the light emitting diode 600 is emitted, faces the lateral side of the base substrate 411.

The scattering member 700 is disposed below the liquid crystal panel 400. In detail, the scattering member 700 is disposed below the base substrate 411. The scattering member 700 comprises a base film 710 and a protrusion pattern 720.

The base film 710 is transparent. For example, resin is used for the base film 710.

The protrusion pattern 720 protrudes from the base film 710. The protrusion pattern 720 can be integrally formed with the base film 710. The number of protrusions per a unit area of the protrusion pattern 720 (hereinafter, referred to as protrusion density) may vary depending on the position in the protrusion pattern 720.

For example, the protrusion density is increased in the second direction. Further, the protrusion density may be gradually increased proportionally to the distance relative to the light emitting diode 600.

The scattering member 700 is disposed such that the protrusion pattern 720 faces the liquid crystal panel 400, and adheres to the base substrate 411 by an adhesive member 800. In detail, the adhesive member 800 adheres to the scattering member 700 while adhering to the base substrate 411.

The adhesive member 800 has a refraction index substantially identical to that of the base substrate 411. In detail, the refraction index of the adhesive member 800 corresponds to that of the base substrate 411.

Thus, light incident into the base substrate 411 can be easily incident into the adhesive member 800. Further, the light incident into the adhesive member 800 is scattered by the protrusion pattern 720.

In detail, since the refraction index of the adhesive member 800 is substantially identical to that of the base substrate 411, the light incident through the lateral side of the base substrate 411 is easily scattered.

According to another embodiment, the refraction index of the adhesive member 800 may be greater than that of the base substrate 411.

For example, the adhesive member 800 may use PSA (pressure sensitive adhesive) and the like.

The light emitted from the light emitting diode 600 is incident through the lateral side of the base substrate 411. The incident light is scattered by the scattering member 700 and then is totally reflected by the base substrate 411.

A part of the incident light is emitted upward and the other part of the incident light is emitted downward. At this time, the light emitted upward is polarized by passing through the polarizing layer 412, and then is used for displaying an image.

Further, the light emitted downward passes through the first prism sheet 310, is reflected by the reflective sheet 200, and then passes through the first prism sheet 310.

The light passing through the first prism sheet 310 twice has properties improved by the first prism sheet 310, and is used for displaying an image.

According to the LCD of the embodiment, the light is incident through the lateral side of the base substrate 411 and an image is displayed by the incident light, so that a light guide plate and the like is not required.

Thus, the LCD according to the embodiment has a slim structure as compared with an existing LCD additionally using a light guide plate.

Further, the polarizing layer 412 is disposed inside the liquid crystal panel 400 and the first prism sheet 310 is interposed between the scattering member 700 and the reflective sheet 200, so that the LCD according to the embodiment can display high quality images.

Further, a driving signal is applied to the liquid crystal panel 400 and the light emitting diode 600 through the connection substrate 500. In other words, the driving signal is applied to the liquid crystal panel 400 and the light emitting diode 600 through one substrate.

Thus, the LCD according to the embodiment can be formed through a simple process.

In addition, the light emitting diode 600 is mounted on the connection substrate 500, so that the light emitting diode 600 can be disposed adjacently to the lateral side of the base substrate 411. Thus, light leaked from the light emitting diode 600 can be reduced.

Consequently, the LCD according to the embodiment has improved brightness.

FIG. 3 is a sectional view showing one section of an LCD according to another embodiment. The present embodiment will further describe a transflective layer with reference to the aforementioned embodiment.

Referring to FIG. 3, the liquid crystal panel 400 comprises a transflective layer 414. The transflective layer 414 is interposed between the polarizing layer 412 and the base substrate 411. The transflective layer 414 allows a part of incident light to pass therethrough and reflect remaining incident light.

The transflective layer 414 is formed by laminating a plurality of transparent layers having refraction indices different from each other.

Light incident into the base film 710 is totally reflected by the base film 710, and a part of the light is totally reflected in the transflective layer 414.

Thus, the light incident into the base film 710 can be uniformly emitted upward, so that the LCD according to the embodiment has improved brightness uniformity.

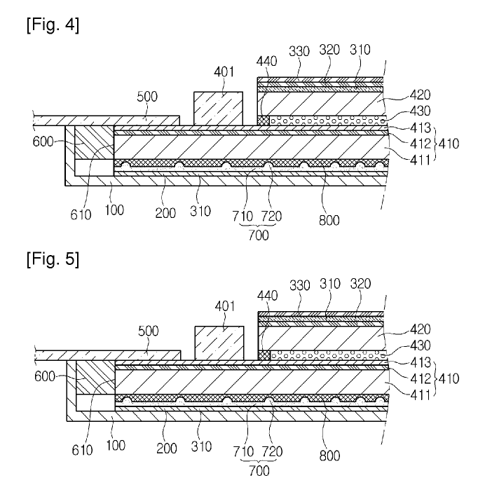

FIGS. 4 and 5 are sectional views showing LCDs according to further another embodiment. The present embodiment will further describe a position of an optical sheet with reference to the aforementioned embodiments.

Referring to FIG. 4, the first prism sheet 310 is interposed between the polarizing sheet 320 and the liquid crystal panel 400. At this time, the first prism sheet 310, the polarizing sheet 320 and the second prism sheet 330 can closely make contact with each other.

Referring to FIG. 5, the first prism sheet 310 can be interposed between the polarizing sheet 320 and the second prism sheet 330.

Since the first prism sheet 310 is disposed on the liquid crystal panel, all lights for displaying images pass through the first prism sheet 310.

Thus, the LCD according to the embodiment can display high quality images.

Although embodiments have been described with reference to a number of illustrative embodiments thereof, it should be understood that numerous other modifications and embodiments can be devised by those skilled in the art that will fall within the spirit and scope of the principles of this disclosure.

### INDUSTRIAL APPLICABILITY

The LCD according to the embodiment is used for displaying images.

1. An LCD comprising:
a first substrate;
a second substrate facing the first substrate;
a liquid crystal layer interposed between the first substrate and the second substrate; and
a light source disposed at a lateral side of the second substrate to emit light toward the second substrate.

2. The LCD as claimed in claim 1, further comprising a polarizing layer interposed between the first substrate and the second substrate.

3. The LCD as claimed in claim 1, further comprising a reflective polarizing film interposed between the first substrate and the second substrate to reflect a part of the light downward.

4. The LCD as claimed in claim 1, further comprising a scattering member disposed below the second substrate and having a scattering pattern.

5. The LCD as claimed in claim 4, further comprising an adhesive member adhering to the scattering member and the second substrate.

6. The LCD as claimed in claim 5, wherein the adhesive member has a refraction index corresponding to a refraction index of the second substrate.

7. The LCD as claimed in claim 1, further comprising:
a first prism sheet disposed on the first substrate;
a second prism sheet disposed below the second substrate; and
a reflective sheet disposed below the first prism sheet.

8. The LCD as claimed in claim 7, wherein the second prism sheet makes contact with the reflective sheet.

9. The LCD as claimed in claim 7, wherein the first prism sheet includes a first prism pattern extending in a first direction and the second prism sheet includes a second prism pattern extending in a second direction.

10. The LCD as claimed in claim 1, further comprising:
a first prism sheet disposed on the first substrate;
a polarizing sheet making contact with the first prism sheet; and
a second prism sheet making contact with the polarizing sheet.

11. An LCD comprising:
a liquid crystal panel including first and second substrates facing each other;
a connection substrate connected with the second substrate; and
a light source mounted on the connection substrate to emit light toward a lateral side of the second substrate.

12. The LCD as claimed in claim 11, wherein the liquid crystal panel comprises a reflective polarizing layer interposed between the first substrate and the second substrate.

13. The LCD as claimed in claim 11, wherein the second substrate comprises:
a transparent or translucent base substrate;
a polarizing layer disposed on the base substrate; and
a plurality of lines formed on the polarizing layer.

14. The LCD as claimed in claim 13, wherein the connection substrate is connected with at least one of the lines.

15. The LCD as claimed in claim 11, wherein the second substrate comprises:
a transparent or translucent base substrate;
a TFT layer formed on the base substrate and including a plurality of lines; and
a polarizing layer formed on the TFT layer.

16. An LCD comprising:
a liquid crystal panel;
a polarizing layer disposed inside the liquid crystal panel;
a scattering member adhering to a bottom surface of the liquid crystal panel; and
a light source disposed at a lateral side of the liquid crystal panel.

17. The LCD as claimed in claim 16, further comprising an optical sheet disposed on the liquid crystal panel.

18. The LCD as claimed in claim 16, further comprising a plurality of layers formed below the polarizing layer and having refraction indices different from each other.

19. The LCD as claimed in claim 16, wherein the scattering member includes a film having a protrusion pattern, and adheres to the liquid crystal panel by an adhesive member interposed between the scattering member and the liquid crystal panel.

20. The LCD as claimed in claim 16, wherein light generated from the light source is incident into the liquid crystal panel through a lateral side of the liquid crystal panel, and an image is displayed by the incident light.
